(19) United States
(12) Patent Application Publication
(10) Pub. No.: US 2015/0248833 A1
(43) Pub. Date: Sep. 3, 2015

(54) WIRELESS WEARABLE APPARATUS, SYSTEM, AND METHOD

(71) Applicant: PROTEUS DIGITAL HEALTH, INC., Redwood City, CA (US)

(72) Inventors: Lawrence Arne, Palo Alto, CA (US); Michael Graves, San Francisco, CA (US); Ilya Ivanchenko, Los Altos, CA (US)

(21) Appl. No.: 14/429,875

(22) PCT Filed: Sep. 18, 2013
(86) PCT No.: PCT/US2013/060453

§ 371 Date: Mar. 20, 2015

Related U.S. Application Data
(60) Provisional application No. 61/704,156, filed on Sep. 21, 2012.

(51) Int. Cl. G08C 17/02; H04W 4/00

(52) U.S. Cl. CPC G08C 17/02; H04W 4/008; H04W 76/023

(57) ABSTRACT

Disclosed is a wireless wearable sensor apparatus. The wireless wearable sensor apparatus includes a sensor platform having a signal processing device with a computational engine to implement signal processing tasks. The sensor platform is configured to receive signals from at least one sensor coupled thereto. A wireless communication circuit is coupled to the sensor platform. The wireless communication circuit comprises a link master controller configured to communicate to a wireless device and transfer data. In one aspect, the link master controller is configured to control data transmission over a communication link established with to wireless device, comprising timing control and frequency control. The wireless wearable sensor may include a processor, a memory, and an accelerometer coupled to the sensor platform.

### CROSS-REFERENCE TO RELATED APPLICATIONS

Pursuant to 35 U.S.C. §119 (e), this application claims priority to the filing date of U.S. Provisional Patent Application Ser. No. 61/704,156 filed Sep. 21, 2012; the disclosure of which is herein incorporated by reference.

### INTRODUCTION

The present disclosure is related generally to a wireless wearable apparatus, system, and method. More particularly, the present disclosure is related to a wireless wearable sensor configured to monitor at least one parameter and to wirelessly communicate the at least one monitored parameter to a communication device. The communication device is configured to communicate the at least one monitored parameter to a remote device over a network. The at least one monitored parameter may include, without limitation, skin impedance, electro cardiogram signals, conductively transmitted current signal, position of wearer, temperature, heart rate, respiration rate, humidity, altitude/pressure, global positioning system (GPS), proximity, bacteria levels, glucose level, chemical markers, blood oxygen levels, among other physiological and physical parameters.

### SUMMARY

In one aspect, a wireless wearable sensor apparatus is provided. The wireless wearable sensor apparatus comprises a sensor platform comprising a signal processing device comprising a computational engine to implement signal processing tasks. The sensor platform is configured to receive signals from at least one sensor coupled thereto. A wireless communication circuit is coupled to the sensor platform. The wireless communication circuit comprises a link master controller to establish a link to communicate with a wireless device and transfer data thereto. In one aspect, the link master controller is configured to control data transmission over a communication link established with the wireless device, comprising timing control and frequency control.

### FIGURES

The novel features of the embodiments described herein are set forth with particularity in the appended claims. The various aspects, however, both as to organization and methods of operation may be better understood by reference to the following description, taken in conjunction with the accompanying drawings as follows.

FIG. 1 is a perspective view of one aspect of a wireless wearable module.

FIG. 2 is a top view of one aspect of the wireless wearable module shown in FIG. 1.

FIG. 3 is a side view of one aspect of the wireless wearable module shown in FIG. 1.

FIG. 4 is another side view of one aspect of the wireless wearable module shown in FIG. 1.

FIG. 5 is a bottom view of one aspect of the wireless wearable module shown in FIG. 1.

FIG. 6 is an exploded view of one aspect of the wireless wearable module shown in FIG. 1.

FIG. 7 is another exploded view of one aspect of the wireless wearable module shown in FIG. 1.

FIG. 8 is a detail view of one aspect of the wireless wearable module shown in FIG. 1.

FIG. 9 is a detail view of one aspect of the view of the wireless wearable module shown in FIG. 8.

FIG. 10 is a top view of one aspect of the wireless wearable module shown in FIG. 1.

FIG. 11 is a detail view of one aspect of the view of the wireless wearable module shown in FIG. 10.

FIG. 12 is a system diagram showing electronic modules of one aspect of the wireless wearable sensor.

FIG. 13 is a diagram of a communication system comprising the wireless wearable sensor in communication with an external device.

### DESCRIPTION

Before explaining the various embodiments of the wireless wearable apparatus, system, and method in detail, it should be noted that the various embodiments disclosed herein are not limited in their application or use to the details of construction and arrangement of parts illustrated in the accompanying drawings and description. Rather, the disclosed embodiments are may be positioned or incorporated in other embodiments, variations and modifications thereof, and may be practiced or carried out in various ways. Accordingly, embodiments of the wireless wearable apparatus, system, and method disclosed herein are illustrative in nature and are not meant to limit the scope or application thereof. Furthermore, unless otherwise indicated, the terms and expressions employed herein have been chosen for the purpose of describing the embodiments for the convenience of the reader and are not to limit the scope thereof. In addition, it should be understood that any one or more of the disclosed embodiments, expressions of embodiments, and/or examples thereof, can be combined with any one or more of the other disclosed embodiments, expressions of embodiments, and/or examples thereof, without limitation.

In the following description, like reference characters designate like or corresponding parts throughout the several views. Also, in the following description, it is to be understood that terms such as front, back, inside, outside, top, bottom and the like are words of convenience and are not to be construed as limiting terms. Terminology used herein is not meant to be limiting insofar as devices described herein, or portions thereof, may be attached or utilized in other orientations. The various embodiments will be described in more detail with reference to the drawings.

The present disclosure is directed generally to various aspects of a wireless wearable apparatus, system, and method for monitoring at least one physiological and/or physical parameter associated with the wearer of the wireless wearable module and for communicating the monitored parameter to a communication device. The communication device is configured to communicate the monitored parameter remotely over a network.

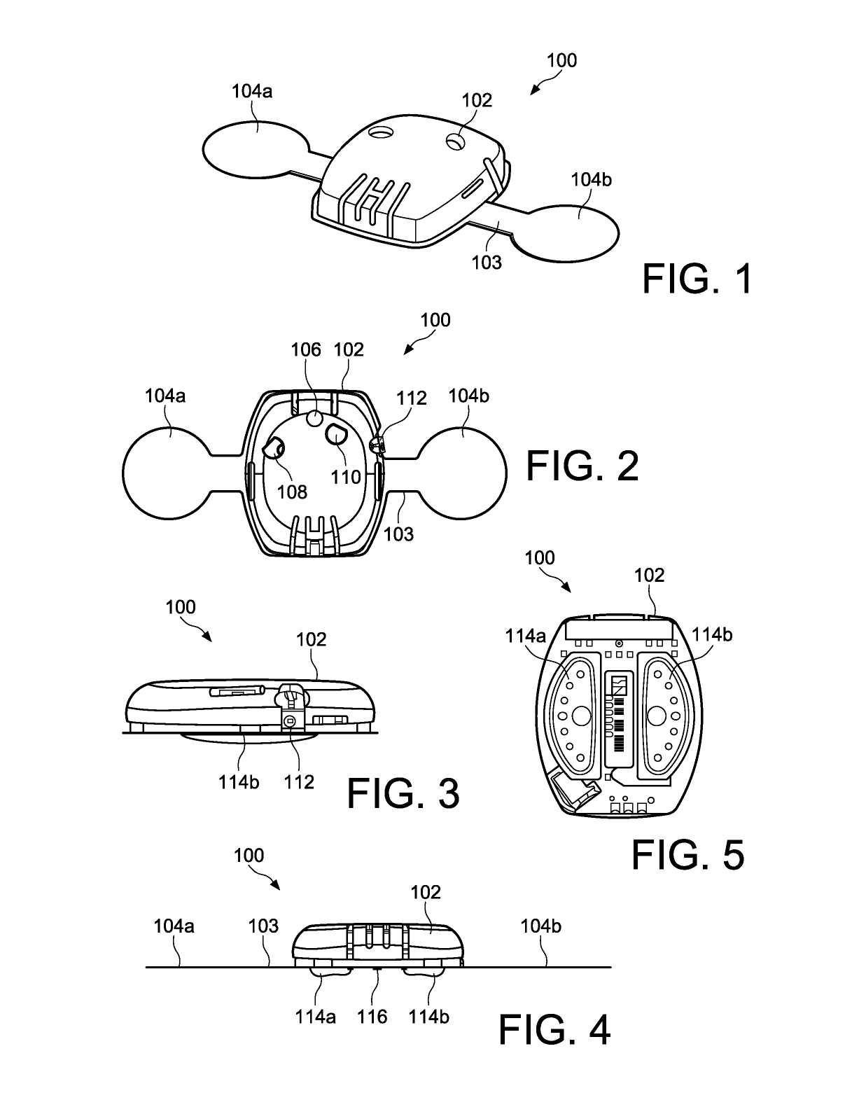

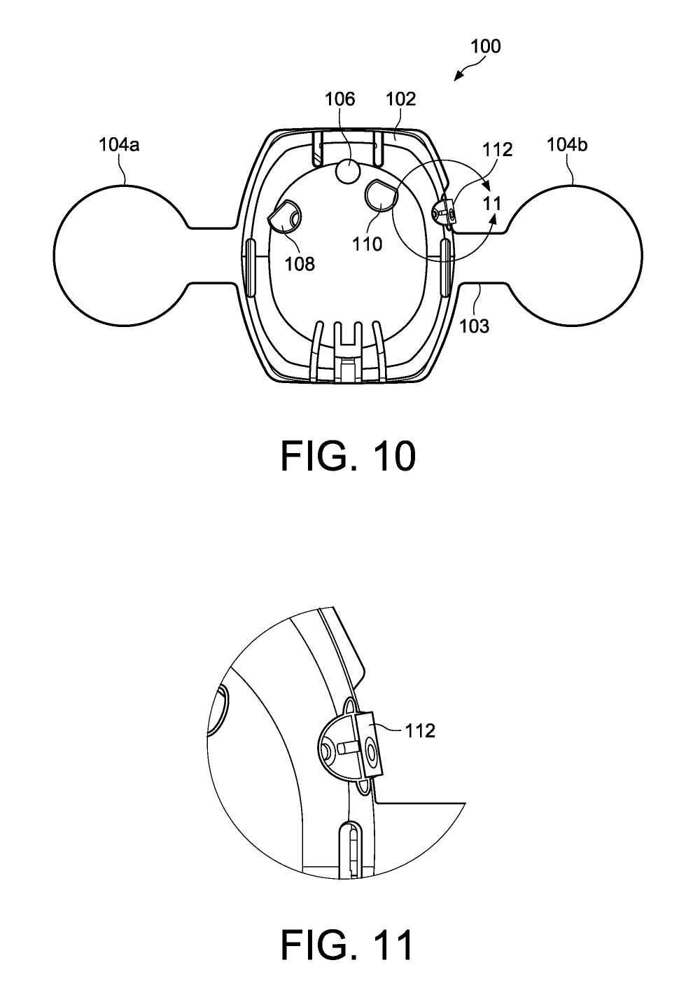

FIGS. 1-11 illustrate various views of one aspect of a wireless wearable module 100 portion of a wireless wearable device. In one aspect, the wireless wearable module 100 is removably attachable to a subject, such as a person or other biological life form. The wireless wearable module 100 is configured to monitor at least one of a physiological and/or physical parameter associated with the subject.

In one aspect, the wireless wearable module 100 comprises various combinations of analog front-end, vector/digital signal processing, microprocessor, and memory in a single low-power application specific integrated circuit (ASIC) customized for the wireless wearable module 100. The “ASIC-based sensor platform” implements multiple functions, including, without limitation: software-defined radio for detection of conductively transmitted current signals such as those produced by an Ingestible Event Marker (IEM) by Proteus Digital Health of Redwood City, Calif. describing sensing and processing of electrocardiograms (ECG), AC skin impedance measurements, temperature measurements, direct current (DC) skin impedance known as galvanic skin response (GSR) measurements and other biological/medical data sensors. Various US and international patents and patent publications described in the following paragraphs describe devices that generate conductively transmitted current signals and receivers configured to detect such conductively transmitted current signals and are hereby incorporated by reference in their entirety.

Application titled Low Voltage Oscillator for Medical Devices, International Publication No. WO 2008/066617 and corresponding US Application, Publication No. US 2010-0214033; application titled Acoustic Pharma-Informatics System, publication number US 2008-0020037; application titled Ingestible Circuitry, International Publication No. WO 2010/019778 and corresponding US Application, Publication No. US 2010-0298668; application titled Identifier Circuits for Generating Unique Identifiable Indicators and Techniques for Producing Same, International Publication No. WO/2010/057049 and corresponding US Application, Publication No. US 2010-0312228; application entitled In-Body Power Source Having High Surface Area Electrode, International Publication No. WO 2008/101107 and corresponding US Application, Publication No. US 2010-0069717; application titled Solid-State Thin-Film Capacitor, International Publication No. WO 2011/011736 and corresponding US Application Publication No. US 2012-0018844; application titled Controlled Activation Ingestible Identifier, International Publication No. WO/2008/052136 and corresponding US Application, Publication No. US 2010-0239616; application titled In-Body Device With Virtual Dipole Signal Amplification, International Publication No. WO/2009/042812 and corresponding US application Publication No. US 2009-0082645; application titled Multi-Mode Communication Ingestible Event Markers and Methods of Using the Same, International Publication No. WO 2009/111664 and corresponding US Application Publication No. US 2009-0256702; application titled In-Body Device Having a Multi-Directional Transmitter, International Publication No. WO 2008/112577 and corresponding US Application Publication No. US 2010-0022836; application titled In-Body Device Having Deployable Antenna, International Publication No. WO 2008/112578 and corresponding US Application, publication number US 2011-0257491; application titled Low Profile Antenna for In-Body Device, Publication No. US 2008-0306360; application titled RFID Antenna for In-Body Device, Publication No. US 2008-0316020; application titled Pharma-Informatics System, International Publication No. WO 2006/116718 and corresponding US Application Publication No. US 2008-0284599; application titled Communication System with a Partial Power Source, Publication No. US 2010-0081894, now U.S. Pat. No. 7,978,064; application titled Communication System with Remote Activation, US Application Publication No. US 2012-0007734; application titled Communication System with Multiple Sources of Power, US Application Publication No. US 2012-0004520; application titled Communication System Using an Implantable Device, US Application Publication No. US 2012-0004527; application titled Communication System with Enhanced Partial Power and Method of Manufacturing Same, US Application Publication No. US 2012-0116188; application titled Polypharmacy Co-Packaged Medication Dosing Unit Including Communication System Therefor, US Application Publication No. US 2012-0024889; application titled Communication System Incorporated in an Ingestible Product, US Application Publication No. US 2012-0062379; application titled Communication System Incorporated in a Container, U.S. application Ser. No. 13/304,274, filed Nov. 23, 2011; application titled Highly Reliable Ingestible Event Markers and Methods for using the Same, International Publication No. WO 2010/129288 and corresponding US Application Publication No. US 2011-0054265; application titled Miniature Ingestible Device, International Publication No. WO 2011/127252; application titled Ingestible Device with Pharmaceutical Product, International Publication No. WO/2012/071280; application titled Wireless Energy Sources for Integrated Circuits, International Publication No. WO/2012/092209; application titled Pharmaceutical Dosages Delivery System, International Publication No. WO 2010/080764 and corresponding US Application Publication No. US 2011-0306852; application titled High-Throughput Production of Ingestible Event Markers, International Publication No. WO 2010-080765 and corresponding US Application Publication No. US 2012-0011699; application titled Ingestible Event Markers Comprising an Ingestible Component, International Publication No. WO 2010-132331 and corresponding US Application Publication No. US 2012-0011699; application titled System for Supply Chain Management, International Publication No. WO 2011-057024 and corresponding US Application Publication No. US 2012-02200838; application titled Integrated Ingestible Event Marker System with Pharmaceutical Product, International Publication No. WO 2011-068963 and corresponding US Application Publication No. US 2012-0116359; application titled Compositions Comprising a Shelf-Life Stability Component, U.S. application Ser. No. 13/304,260, filed Nov. 23, 2011.

Application titled Body-Associated Receiver and Method, International Publication No. WO 2010/075115; and corresponding US Application Publication No. US 2010-0312188, now U.S. Pat. No. 8,114,021; application titled Apparatus and Method for measuring Bio-Chemical Parameters, International Publication No. WO 2011-022732 and corresponding US Application Publication No. US 2012-0146670; application entitled Evaluation of Gastrointestinal Function Using Portable Electroviscerography Systems and Methods of Using the Same, International Publication No. 2010/068818 and corresponding US Application Publication No. US 2011-0040203, now U.S. Pat. No. 8,055,334; application titled Two-Wrist Data-Gathering System, International Publication No. WO 2011-094608 and corresponding US Application Publication No. US 2012-0022341; application titled Wrist Data-Gathering System, International Publication No. WO 2011-094606 and corresponding US Application Publication No. US 2012-0116201; application titled Wearable Personal Communicator Apparatus, System, and Method, International Application Publication No. WO 2012/112561; application titled Biological Sample Collection Device and System, International Application No. PCT/US12/028342, filed Mar. 8, 2012; application titled Wearable Personal Body Associated Device with Various Physical Configurations, International Application No. PCT/US12/028343, filed Mar. 8, 2012; application titled Body Associated Device and Method of Making Same, International Application No. PCT/US12/035650, filed Apr. 27, 2012; application titled Mobile Communication Device, System and Method, International Application No. PCT/US12/047076, filed Jul. 17, 2012; application titled Transbody Communication Systems Employing Communications Channels, International Publication No. WO 2009/070773 and corresponding US Application Publication No. US 2009-0135886; application titled Active Signal Processing Personal Health Signal Receivers, International Publication No. WO 2008/063626 and corresponding US Application Publication No. US 2010-0316158; and application titled Method and System for Incorporating Physiologic Data in a Gaming Environment, International Publication No. WO 2010/045385 and corresponding US Application Publication No. US 2011-0212782.

In one aspect, the wireless wearable module 100 comprises a combination of an ASIC-based sensor platform with low-power wireless communication circuit to connect to other wireless devices (cell-phones, smart phones, tablet computers, laptop computers, gateway devices, among others).

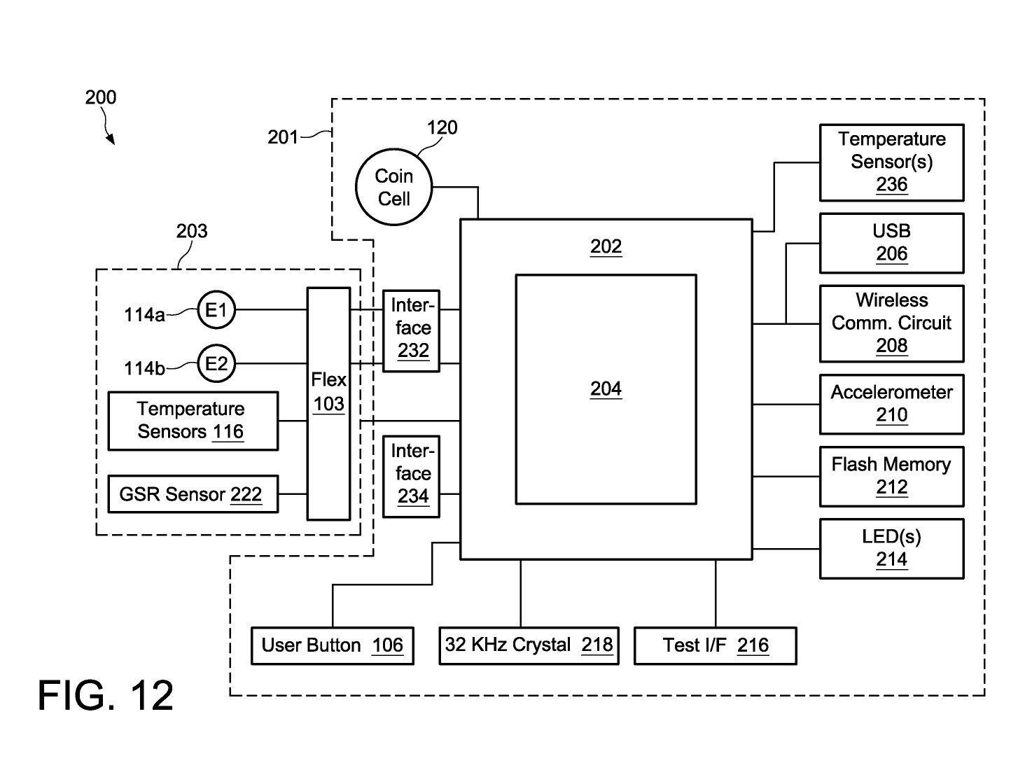

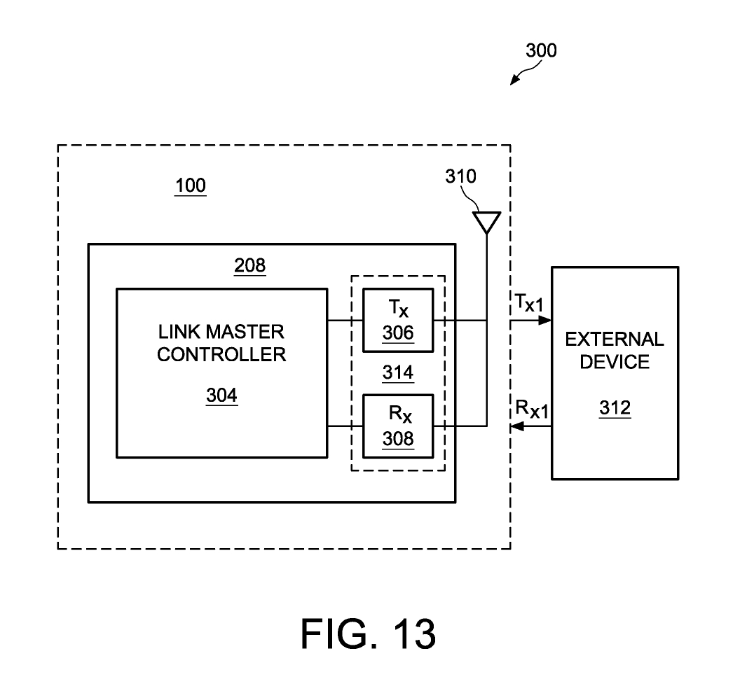

In one aspect, the wireless wearable module 100 provides low battery power usage by means of data records transmission with confirmation of successful transmission. This and other aspects of the wireless wearable module are described in hereinbelow in connection with FIGS. 12 and 13.

Still with reference to FIGS. 1-11, in general aspects, the wireless wearable module 100 is a multi-function device. In one aspect, the wireless wearable module 100 can detect and decode information or data associated with an electronic device located within a user's body as well as measure physiological data about the user and transmits the data to a third or external device. The wireless wearable module 100 is battery powered. In one aspect, the battery may be rechargeable. The wireless wearable module 100 comprises a user interface which includes one or more input means 106 (push-button, tap detect) as well as indicator means 108, 110 (light emitting diodes). In addition, a third or external device may implement part or all of the user interface functions.

The wireless wearable module 100 comprises multiple electrodes 104a, 104b, or more, for detecting information or data associated with the user's body. In one aspect, the electrodes 104a, 104b are a wet electrode in the form of a gel, such as a hydrogel, for example. In one aspect, there are two 104a, 104b or three electrodes and each is in contact with the body of the subject. In an alternative aspect, the electrodes 104a, 104b may be a dry electrode type. The dry electrodes operate in contact with or close to the body (perhaps separated by a layer of clothing) and the contact to the body may be either capacitive-only, or a combination of capacitive and resistive contact (as with wet electrodes). In a third aspect, both dry and wet electrodes may be present for different sets of data.

The skin electrodes 104a, 104b may be configured in some aspects with a plurality of small domes, cones, or other patterns to facilitate contact with skin in cases where excessive hair may otherwise make such contact difficult. The wireless wearable module 100 may use Acrylic and or Hydrocolloid and/or Silicone based adhesive materials and combinations of both.

In one aspect, the wireless wearable module 100 may comprises stainless steel domed electrodes 114a, 114b intended to interface with the skin and measure GSR also called electro dermal response (EDR). This measure is traditionally used in lie detectors and also in the measurement of stress or physical activity and may be employed to detect anything that may change a concentration of sweat in the measurement area.

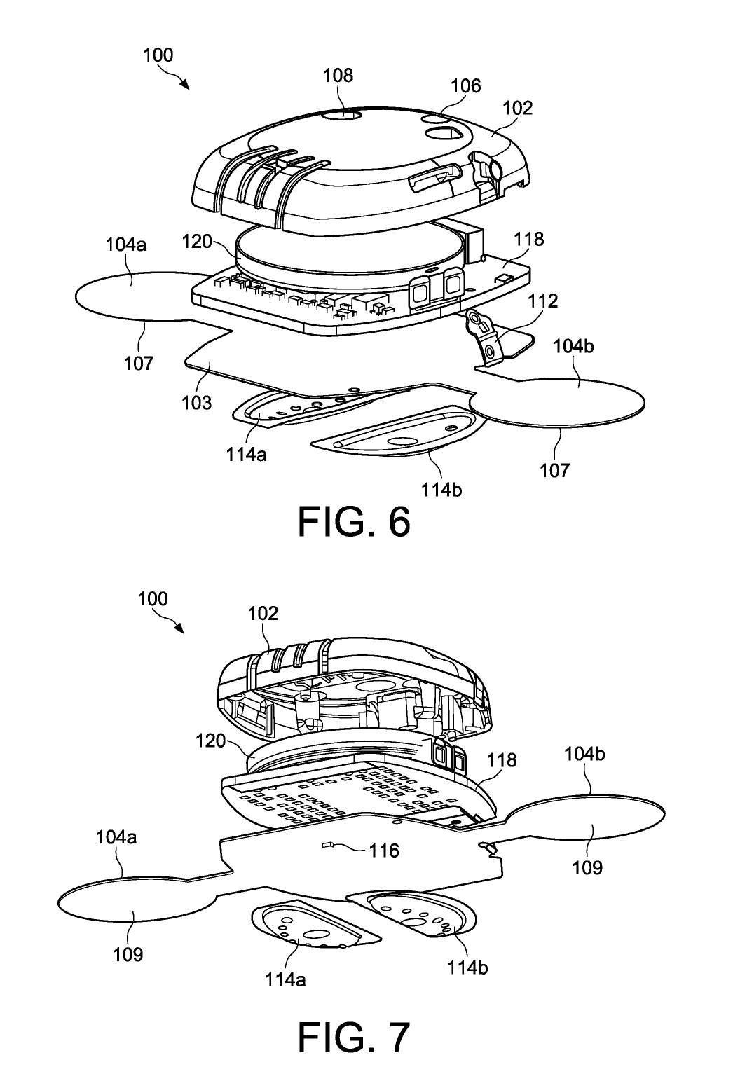

In one aspect, the wireless wearable module 100 comprises a housing 102, otherwise referred to as a top cover. In one aspect, the top cover may be covered by a layer of foam or other suitable materials. Within the housing 102, as shown in FIGS. 6 and 7, the wireless wearable module 100 comprises a printed circuit board assembly 118 (PCBA). The PCBA 118 comprises a battery 120 (e.g., coin cell) and the electronics circuit portion of the device 100. The PCBA 118 also comprises temperature measuring devices designed to measure and record, skin, ambient and circuit board temperature. The temperature measuring devices may be used to measure heat flux between the skin and the ambient temperature sensor.

A flex circuit 103 is electrically coupled to the PCBA 118. The flex circuit 103 comprises the electrodes 104a, 104b and, in one aspect, additional electrical sensors. The flex circuit 103 comprises interface components that electrically interfaces with the electrical circuits on the PCBA 118. The flex circuit 103 provides a platform for configurability and enables interfacing of multiple sensor configurations to a single physical PCBA 118 and electrically to an electronic module, as described hereinbelow in connection with FIG. 12. In one aspect, the stainless steel domed electrodes 114a, 114b of the GSR/EDA sensor are electrically coupled to the PCBA 118 via the flex circuit 103. In one aspect, a temperature sensor 116 is connected to the flex circuit 103. In one aspect, the flex circuit 103 comprises an adhesive material 107 that enables coupling (attachment) of the wireless wearable module 100 to the body of the subject. The adhesive material 107 may be breathable, dual, hybrid, split, hydrocolloid, etc. A tie layer is provided to couple the flex circuit 103 to the skin adhesive layer and create a hermetic barrier. An electrode hydrogel material (not shown) may be provided on the body attachment side of the electrodes 104a, 104b to assist electrical coupling of the electrodes 104a, 104b to body of the subject. A release liner 109 is provided over the adhesive material 107 to protect the adhesive material 107 until time of attachment to subject.

In one aspect, the wireless wearable module 100 may comprise one or more buttons 106 for use by the subject to turn on and initiate other operations of the wireless wearable module 100.

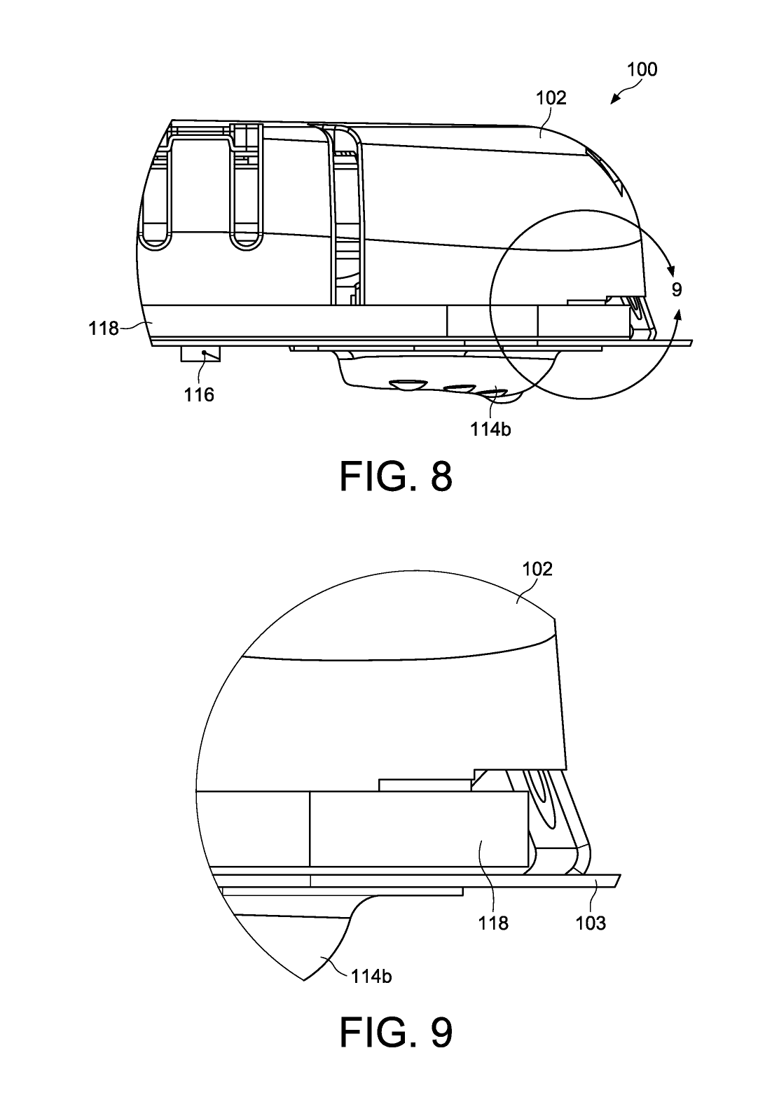

FIG. 12 is a system diagram 200 of one aspect of the wireless wearable module 100. In one aspect, the wireless wearable module 100 comprises a first electronic module 201 and a wireless communication circuit 208, such as an RF wireless circuit. The first electronic module 201 comprises an ASIC-based sensor platform 202 that includes a hardware architecture and software framework to implement various aspects of the wireless wearable module 100. In one aspect, the ASIC-based sensor platform 202 may be disposed on and interfaced with the PCBA 118 (FIGS. 7 and 8). The wireless communication circuit 208 may be low power and is configured to connect to other wireless devices (cell-phones, smart phones, tablet computers, laptop computers, gateway devices, among others). A second electronic interface module 203 interfaces with PCBA 118 and the first electronic module 201. In one aspect, the electronic modules 201, 203 each may comprises additional modules that reside on or off the PCBA 118 or, in another aspect may be disposed on the PCBA 118.

In one aspect, the first electronic module 201 provides a sensor platform and comprises circuits designed to interface with different sensors and comprises various combinations of the following components. In various aspects, the first electronic module 201 ASIC-based sensor platform provides a combination of analog front-end, vector/digital signal processing, microprocessor and memory in a single low-power ASIC/chip that comprises an “ASIC-based sensor platform” with multiple functions: software-defined radio for detection of ingestible event markers, sensing and decoding of ECG, AC skin impedance measurements, temperature measurements, DC skin impedance (e.g., GSR) measurements and other biological/medical data sensors.

In one aspect, the first electronic module 201 comprises an ASIC sensor platform 202, a controller or processor 204, e.g., a microcontroller unit (MCU), a radio frequency (RF) wireless circuit 208, among other components described hereinbelow.

In one aspect, the ASIC portion 202 of the first electronic module 201 may comprise a core processor 204 such as, for example, a 32-bit microprocessor, for real-time applications, a signal processing device such as, for example, a Vector Math Accelerator, program memory, data memory, serial interfaces such as, for example, SPI, universal asynchronous receiver transmitter (UART), two-wire multi-master serial single ended bus interface (I2C), general purpose input/output (GPIO), a real-time clock, an analog-to-digital converter (ADC), gain and conditioning circuits for bio-potential signals, light emitting diode (LED) drivers, among other components. The first electronic module 201 also comprises a connection port to external memory, a connection port to external sensors, and a hardware accelerator. The processor 204 receives a signal from each of the sensors by operating the analog front end for analog sensors and by receiving digital data from sensors with the ADC digitizer. The processor 204 then processes the data and stores the results into the memory 212 in form of data records. In one aspect, the processor 204 may have a very long instruction word (VLIW) processor architecture.

In one aspect, the first electronic module 201 also comprises a universal serial bus 206 (USB), an accelerometer 210, flash memory 212, one or more LEDs 214, test interface 216 (I/F), a 32 KHz crystal 218, a user button 106 that may be used to initiate a communication connection with an external device, sensor interfaces 232, 234, and a battery 120 (e.g., coin cell, primary battery cell). In one aspect, the battery 120 may a rechargeable cell rather than a primary battery cell. In other aspects, the first electronic module 201 may comprise a gyroscope, and circuits for processing ECG, temperature, and accelerometer signals. In other aspects, the first electronic module 201 also may comprise body composition and SpO₂ pulse oximetry circuits that monitor functional oxygen saturation of arterial blood by calculating the ratio of oxygenated hemoglobin to hemoglobin that is capable of transporting oxygen. An SpO2 pulse oximetry circuit may be configured to provide continuous, noninvasive measurements of SpO2 and, in one aspect, can display a plethysmographic waveform. Heart rate values are may be derived from the pulse oximetry signal.

In one aspect, the first electronic module 201 comprises an RF wireless circuit 208. The RF wireless circuit 208 comprises an antenna to receive and transmit wireless signals, a transmitter circuit, a receiver circuit, and a link master controller that includes a mechanism to connect (establish a link) to another, external, wireless device and transfer data, as described in more detail hereinbelow. In one aspect, the link master controller establishes connection to an external device. As a master of the link, the link master controller performs control of data transmission over the link to the external device, including timing control and frequency control (e.g., radio, channel hopping, adaptive frequency control, and the like, without limitation). In one aspect and without limitation to the following implementation, the link master controller can be configured to avoid repeating the transmission of the data records that already have been transmitted, which improves battery 120 power use for a longer operation. In one aspect, the link master controller sends a signal to the external device with an instruction that gives number of data records stored in memory (a total number of all data records and a total number of records of each data type). After each connection, the processor 204 continues to receive all sensor signals, processes the data and stores new data records into the memory 212. Upon each subsequent connection link master controller sends a signal to an external device with new data records since last connection and confirms that records were transmitted successfully. The link master controller avoids repeating the transmission of the data records that already have been transmitted, which improves battery 120 power use for a longer operation and resends all data records that were not transferred successfully. In one aspect, the RF wireless circuit 208 comprises a Bluetooth transmitter processor (BTP). A connection port controls the RF wireless circuit 208.

In one aspect, the first electronic module 201 comprises sensor interfaces 232, 234 between the electrodes 104a, 104b and one or more band pass filters or channels. The sensor interfaces 232, 234 provide an analog front end and may include programmable gain or fixed gain amplifiers, programmable low-pass filter, programmable high-pass filter. The sensor interfaces 232, 234 may comprise active signal conditioning circuits including strain gauge measurement circuits, for example. One channel receives low frequency information associated with the physiological data of the subject (e.g., user) and the other channel receives high frequency information associated with an electronic device within the subject. In one alternative aspect, an additional channel is provided for receiving DC data of the subject. The high frequency information is passed to a digital signal processor (DSP) implemented in the ASIC portion 202 and then to a processor 204 (e.g., a control processor) portion of the wireless wearable module 100 for decompression and decoding. The low frequency information is either passed to the DSP portion of the ASIC portion 202 and then to processor 204, or passed directly to the processor 204. The DC information is passed directly to the processor 204. The DSP portion of the ASIC portion 202 and the processor 204 decode the high frequency, low frequency and DC information or data. This information is then processed and prepared for transmission.

In one aspect, signal processing may or may not be applied to the raw data collected. Signal processing may occur in the real space, complex number space, or in the polar coordinates space. Functions include filters, e.g., finite impulse response (FIR) and infinite impulse response (IIR), mixers, fast Fourier transforms (FFTs), cordics, and others. Raw data may simply be stored and processed downstream. The signal processing may occur in the processor (e.g., a 32-bit microprocessor) or may occur in the signal processing accelerator which is incorporated into the ASIC portion 202.

In one aspect, the first electronic module 201 comprises an accelerometer 210 and one or more temperature sensors 236. In one aspect, two temperature sensors are provided that are identical but placed in different locations—one close to the skin, another close to the ambient for measuring additional data. The temperature measuring devices 236 may be configured to measure and record, skin, ambient, and circuit board temperature. The temperature measuring devices may be used to measure heat flux between the skin and the ambient temperature sensor. In one aspect, the temperature sensor 236 or sensors are thermistor devices with negative temperature coefficient (NTC) or positive temperature coefficient (PTC), and in another aspect temperature sensor 236 or sensors are using integrated semiconductor devices. This information is provided to the processor 204 and can be processed by the processor 204 and prepared for transmission by a transmitter portion of a radio 208. The physiological information measured is processed by the processor 204 and may be transmitted as real-time or raw data, or derived quantities or parameters may be transmitted. In one aspect, the ASIC portion 202 incorporates a current source to drive measurements of a resistive sensor. Since the current source has limited accuracy, a reference resistor may be provided to calibrate the errors in the current source and the ADC.

In one aspect, the accelerometer 210 may be a 3-axis accelerometer with a resampling frequency correction processor. Digital accelerometer 210 sensors usually include a MEMS-based acceleration sensor element, a digitizer, and digital interface control logic. Typically these accelerometers use resistor-capacitor (RC) oscillator with low accuracy to strobe the digitizer sampling input. In order to employ signals from such accelerometer 210 in signal processing algorithms the accuracy of RC oscillators is not sufficient. Accordingly, in one aspect, the first electronic module 201 comprises an accelerometer sampling frequency correction processor that takes signals from the accelerometer 210 and performs re-sampling to compensate for the RC oscillator error.

In one aspect, the accelerometer 210 sampling frequency correction processor comprises a reference clock (high accuracy oscillator), a fixed up-sample block, a digital filter, a programmable down-sample block, and a control circuit that selects down-sample coefficient based on comparison of timing of the signal from accelerometer and the reference clock. The resampling function keeps alignment (e.g., synchronization or in tune) to a reference clock in a sliding window to generate a precise sampling rate. An algorithm calibrates the real time 32 kHz clock 218. The accelerometer 210 sampling frequency correction processor sets the down-sampling coefficient for each frame of data from the accelerometer signal. The present approach provides tracking the timing of the accelerometer signal continuously and selecting the down-sampling coefficient to minimize the accumulated timing error. That allows continuous accelerometer 210 digital data to align to the accurate clock with high precision.

In one aspect, the first electronic module 201 employs a low-power low-memory data storage and transfer scheme. In one aspect, storage and transfer of data in the wireless wearable module 100 memory 212 is optimized for low-power and low memory usage. In one aspect, sensor data can be stored as records in the memory 212, each with a type identifier. In one aspect, records can be transferred in a packet payload to an external device by the RF wireless circuit 208 in the same format as stored on the wireless wearable module 100. In one aspect, records can be stored sequentially with variable length to optimize space usage. In one aspect, a data directory may be included which allows fast record read access from the memory 212. In one aspect, a data directory may be included which allows fast counting of the data records by type.

In one aspect, the first electronic module 201 employs a high-assurance integrity data storage and transfer scheme. In one aspect, the wireless wearable module 100 memory storage and transfer scheme is designed for high-assurance data integrity. In one aspect, for each data record stored in the memory 212 of the wireless wearable module 100, there is an error-detecting code that can be used to detect data record corruption. In one aspect, when the wireless wearable module 100 reads a data record from the memory 212 prior to data packet transfer to the external device, the error-detecting code is checked. In one aspect, when the wireless wearable module 100 detects corruption of the stored data record, an error signal is sent to an external device by the RF wireless circuit 208. In one aspect, each packet transferred from the wireless wearable module 100 to the external device contains an error-detecting code which can be used by the external device to detect packet corruption. In one aspect, after detecting a corrupted packet, the external device can invoke the wireless wearable module 100 to resend data records that were not transferred successfully.

In one aspect, the first electronic module 201 allows for unlimited data logging when powered and connected to an external device. The electronic module 201 is able to detect when non-volatile log memory is nearly full and replace the earliest data records with the most recent data records. When the electronic module 210 is connected to an external device, it is able to transfer all measurements recorded during the lifetime of the electronic module 201. The link master controller may delete from the memory all or some successfully transferred data records at a later time (for example, when the memory 212 gets full).

In one aspect, the signal processing accelerator portion of the ASIC portion 202 includes a computational engine optimized for implementing high efficiency signal processing tasks. In one implementation, signal processing functions are hard coded in logic. Such implementations may be 10× or more efficient compared to software-based algorithms implemented in software running on a processor 204 or microcontroller unit. The efficiency may be in chip sized, power consumption, or clock speed or some combination of all three. Another implementation maintains some level of programmability, but utilizes one or more than one execution unit that is optimized for calculations. One example is an FFT-butterfly engine. The engine may enable FFT calculations for various size data sets, but maintain significant efficiency improvement over software running on a processor 204. The execution units also may be multiply accumulate units (MAC), which are a common DSP function block or could be a floating point calculation unit(s) or FIR filter primitives, etc. In these cases the efficiency for a given integrated circuit process is greater than that of software on a processor 204, but less than that of dedicated hardware, however they are much more flexible.

The signal processing accelerator maintains an interface between the processor 204. This interface may include first-in-first-out (FIFO) registers, dual port memories, the processor's 204 direct memory access (DMA) engine, and/or registers. The interface typically includes some form of contention recognition or avoidance which may be handled at the register-level or at the memory block level. Mechanisms involved may include register flags set, which can be polled by the processor 204 and signal processing accelerator, interrupts to signal either block or delay functions that hold a read or write request until the higher priority device has completed their activity.

In one aspect, the second electronics interface module 203 is coupled to the first electronics module 201 on the PCBA 118 with one or more sensors attached for interface to the item to be monitored (person, animal, machine, building, etc.). The second electronics interface module 203 comprises a flex circuit 103, battery holder or housing 102 (covering) and one or more sensors, including but not limited to ambient and body temperature 116 (living or not), ECG, GSR/electro-dermal activation (EDA) 222, body composition (50 Hz), SpO2/pulse oximetry, strain gauge, among others. Various algorithms executed by the ASIC portion 202 or the processor 204 provide heat flux, HR, HRV, respiration, stress, ECG, steps, body angle, fall detection, among others.

In one aspect, the flex circuit 103 comprises interface components that electrically interfaces with the electrical circuits on the PCBA 118 (FIGS. 6 and 7). The flex circuit 103 provides a platform for configurability and enables interfacing of multiple sensor configurations to a single physical PCBA 118 and electrically to the first electronic module 201. In one aspect, the stainless steel domed electrodes 114a, 114b of the GSR/EDA sensor 222 are electrically coupled to the PCBA 118 via the flex circuit 103.

The first and second electronics modules 201, 203 collect data from various sensors, applies signal processing algorithms to the data collected, stores the resulting information in memory, and forwards data/information to another device using either a wireless or wired connection. The user interface consists of one or two LEDs 214 and a push-button 106. Power is provided from a primary coin-cell battery 120, but could also be sourced from a secondary battery. The sensor data may include ECG data (via hydrogel electrodes) 114a, 114b, accelerometry data in up to 3 axis, temperature data, adjacent to skin (thermistor), ambient (or case temperature away from body) (thermistor), temperature on the PCBA 118 (silicon device incorporated into the ASIC portion 202), GSR, EDA (discrete stainless-steel electrodes), high-frequency, in-body electric signals—10 KHz and higher, sampled via conduction through the hydrogel skin electrodes (same as ECG)

FIG. 13 is a diagram of a communication system 300 comprising the wireless wearable module 100 in communication with an external device 312. As shown in FIG. 13, the wireless wearable module 100 comprises an RF wireless circuit 208. In one aspect, the RF wireless circuit 208 comprises a transceiver 314 coupled to one or more antennas 310 and a link master controller 304. The transceiver 314 comprises a transmitter 306 and a receiver 308. In one aspect, the wireless wearable module 100 receives information form an ingestible event marker (IEM) by Proteus Digital Health, (associated with the high and low frequency information). The wireless wearable module 100 may communicate that information to an external device 312, which receives wireless communication of information from the wireless wearable module 100 and communicates information back to the wireless wearable module 100. The external device 312 is located outside the subject's body, and in various aspects may be, for example, a cell phone, smart phone, tablet computer, a base station, a central data facility, or a computer. The communication link between the wireless wearable module 100 and the external device 312 is a duplex (two-way) communication system, wherein information can be sent to (Tₓ₁) to the external device 312 and received (Rₓ₁) from the external device 312. Thus, the external device 312 sends information to the wireless wearable module 100 AND the wireless wearable module 100 sends information to the external device 312.

In one aspect, the wireless wearable module 100 is the master and the external device 312 is the slave. The external device 312 does not change the form or arrangement of data. The external device 312 does not direct transmission Tₓ₁ of data or the manner in which data are transmitted. In accordance with one aspect, the RF wireless circuit 208 of the wireless wearable module 100 includes a blue-tooth transmitter processor (BTP) that is in communication with the processor 204 (e.g., the control processor). The communication link Tₓ₁/Rₓ₁ may be based on Bluetooth. It also may be configured to use Bluetooth Low Energy (BLE), a combination of both BT and BLE, ANT, Zigbee, or other low power communications methods and other general communication methods (WiFi and cellular telephone technology). The processor 204 sends the information to the BTP and the BTP encrypts and transmits the information to the external device 312. At the point of transmission, the BTP encrypts the data to secure it using a random number, which is generated as part of the communication protocol. The wireless wearable module 100 may break off communication with the external device 312 and pair with a different external device. The external device 312 may un-pair with the wireless wearable module 100 and then pair with a different wireless wearable module. In an alternative aspect the external device 312 is the master and the wireless wearable module 100 is the slave.

In an alternative aspect, the BTP is not present in the RF wireless circuit 208, and the data is sent over an electrical connection, which is established with the external device 312 after the wireless wearable module 100 has completed collecting all the data and is disconnected (removed) from the subject's body. In one aspect, the electrical connection may be completed through a dedicated set of electrical contacts, like a USB 206 (FIG. 12) connection that are covered and protected by patch enclosure from the environment and from making contact with the subject and the enclosure is opened or punctured to make electrical contact. In another aspect, the electrical connection is made to the same dry electrodes 114a, 114b (FIG. 12) that are used for data collection from the subject, and the dry electrodes 114a, 114b are reused for data transmission to the external device 312 after data collection. In this aspect, there are two electrical circuits: a first transmitter 306 circuit that transmits the data to the external device 312 and provides electrical safety to the subject, and a second circuit that detects that the connection to the subject is established and it prevents the first transmitter 306 circuit from sending the data. This functionality serves as a mechanism for conserving battery and does not create additional currents for user comfort (these currents are within safe range established by the first circuit, so it is not a safety mechanism). These various aspects also may include a connector and an adapter.

As previously discussed, the external device 312 may be a telephone such as cell phone or smart phone. Once the external device 312 receives the data transmission from the RF wireless circuit 208, the external device 312 can process the data and either transmit data back to the RF wireless circuit 208 on the wireless wearable module 100 or transmit the data to another device. In one aspect, the external device 312 may comprise phone/server applications and algorithms to calculate sleep, activity classification, gait/imbalance, stress, calorie consumption, hydration, among others, based on the data received from the RF wireless circuit 208. In other aspects, the external device 312 may comprise sensor(s), such as, for example, temperature sensor(s), location sensor(s), among others. In one aspect, the external device 312 may be an attachment or an integral part of the wearable module 100 itself, the attachment or the integral part performing all the functions of a cell phone or a smart phone etc.

While various details have been set forth in the foregoing description, it will be appreciated that the various aspects of the wireless wearable apparatus, system, and method may be practiced without these specific details. For example, for conciseness and clarity selected aspects have been shown in block diagram form rather than in detail. Some portions of the detailed descriptions provided herein may be presented in terms of instructions that operate on data that is stored in a computer memory. Such descriptions and representations are used by those skilled in the art to describe and convey the substance of their work to others skilled in the art. In general, an algorithm refers to a self-consistent sequence of steps leading to a desired result, where a “step” refers to a manipulation of physical quantities which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities.

Unless specifically stated otherwise as apparent from the foregoing discussion, it is appreciated that, throughout the foregoing description, discussions using terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It is worthy to note that any reference to “one aspect,” “an aspect,” “one embodiment,” or “an embodiment” means that a particular feature, structure, or characteristic described in connection with the aspect is included in at least one aspect. Thus, appearances of the phrases “in one aspect,” “in an aspect,” “in one embodiment,” or “in an embodiment” in various places throughout the specification are not necessarily all referring to the same aspect. Furthermore, the particular features, structures or characteristics may be combined in any suitable manner in one or more aspects.

Some aspects may be described using the expression “coupled” and “connected” along with their derivatives. It should be understood that these terms are not intended as synonyms for each other. For example, some aspects may be described using the term “connected” to indicate that two or more elements are in direct physical or electrical contact with each other. In another example, some aspects may be described using the term “coupled” to indicate that two or more elements are in direct physical or electrical contact. The term “coupled,” however, also may mean that two or more elements are not in direct contact with each other, but yet still co-operate or interact with each other.

Although various embodiments have been described herein, many modifications, variations, substitutions, changes, and equivalents to those embodiments may be implemented and will occur to those skilled in the art. Also, where materials are disclosed for certain components, other materials may be used. It is therefore to be understood that the foregoing description and the appended claims are intended to cover all such modifications and variations as falling within the scope of the disclosed embodiments. The following claims are intended to cover all such modification and variations.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

In summary, numerous benefits have been described which result from employing the concepts described herein. The foregoing description of the one or more embodiments has been presented for purposes of illustration and description. It is not intended to be exhaustive or limiting to the precise form disclosed. Modifications or variations are possible in light of the above teachings. The one or more embodiments were chosen and described in order to illustrate principles and practical application to thereby enable one of ordinary skill in the art to utilize the various embodiments and with various modifications as are suited to the particular use contemplated. It is intended that the claims submitted herewith define the overall scope.

Although various embodiments have been described herein, many modifications, variations, substitutions, changes, and equivalents to those embodiments may be implemented and will occur to those skilled in the art. Also, where materials are disclosed for certain components, other materials may be used. It is therefore to be understood that the foregoing description and the appended claims are intended to cover all such modifications and variations as falling within the scope of the disclosed embodiments. The appended claims are intended to cover all such modification and variations.

In summary, numerous benefits have been described which result from employing the concepts described herein. The foregoing description of the one or more embodiments has been presented for purposes of illustration and description. It is not intended to be exhaustive or limiting to the precise form disclosed. Modifications or variations are possible in light of the above teachings. The one or more embodiments were chosen and described in order to illustrate principles and practical application to thereby enable one of ordinary skill in the art to utilize the various embodiments and with various modifications as are suited to the particular use contemplated. It is intended that the claims submitted herewith define the overall scope.

Some or all of the embodiments described herein may generally comprise technologies which can be implemented, individually, and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general or specific purpose computer configured by a computer instructions which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory.

Various aspects of the subject matter described herein are set out in the following numbered clauses:

1. A wireless wearable sensor apparatus, comprising: a sensor platform comprising a signal processing device comprising a computational engine to implement signal processing tasks, the sensor platform configured to receive signals from at least one sensor coupled thereto; and a wireless communication circuit coupled to the sensor platform, wherein the wireless communication circuit comprises a link master controller configured to communicate with a wireless device and transfer data thereto.

2. The wireless wearable sensor of clause 1, wherein the link master controller is configured to control data transmission over a communication link established with the wireless device, comprising timing control and frequency control.

3. The wireless wearable sensor apparatus of clause 1, wherein the signal processing device comprises hard coded signal processing functions.

4. The wireless wearable sensor apparatus of clause 1, wherein at least a portion of the signal processing device comprises programmable signal processing functions and execution units for optimized calculations.

5. The wireless wearable sensor apparatus of clause 1, wherein the signal processing device comprises an interface to a processor.

6. The wireless wearable sensor apparatus of clause 5, wherein the interface comprises: at least one first-in-first-out (FIFO) register; dual port memories; and a direct memory access (DMA) engine to directly access processor memory.

7. The wireless wearable sensor apparatus of clause 5, wherein the interface comprises contention recognition or avoidance.

8. The wireless wearable sensor apparatus of clause 1, further comprising an electronics interface module coupled to the sensor platform.

9. The wireless wearable sensor apparatus of clause 8, comprising: a sensor interface coupled to the sensor platform; a flex circuit coupled to the sensor interface; and one or more sensors coupled to the flex circuit.

10. A wireless wearable sensor apparatus, comprising: a sensor platform comprising a signal processing device comprising a computational engine to implement signal processing tasks, the sensor platform configured to receive signals from at least one sensor coupled thereto; a wireless communication circuit coupled to the sensor platform, wherein the wireless communication circuit comprises a link master controller configured to establish a link to communicate with a wireless device and transfer data thereto; and an accelerometer coupled to the sensor platform.

11. The wireless wearable sensor apparatus of clause 10, wherein the link master controller is configured to control data transmission over a communication link established with the wireless device, comprising timing control and frequency control.

12. The wireless wearable sensor apparatus of clause 10, further comprising a resampling frequency correction processor.

13. The wireless wearable sensor apparatus of clause 12, wherein the resampling frequency correction processor is provided in the accelerometer.

14. The wireless wearable sensor apparatus of clause 12, wherein the resampling frequency correction processor is provided in the signal processing device.

15. The wireless wearable sensor apparatus of clause 12, wherein the resampling frequency correction processor comprises: a reference clock; a fixed up-sample block; a digital filter; a programmable down-sample block; and a control circuit that selects a down-sample coefficient based on comparison of timing of an accelerometer signal and the reference clock.

16. The wireless wearable sensor apparatus of clause 12, wherein the resampling frequency correction processor is configured to synchronize to a reference clock in a sliding window to generate a precise sampling rate.

17. The wireless wearable sensor apparatus of clause 12, wherein the resampling frequency correction processor is configured to set the down-sampling coefficient for each frame of data from the accelerometer signal.

18. The wireless wearable sensor apparatus of clause 12, wherein the resampling frequency correction processor is configured to track an accelerometer timing signal continuously and select the down-sampling coefficient to minimize any accumulated timing error.

19. A wireless wearable sensor apparatus, comprising: a sensor platform comprising: a signal processing device comprising a computational engine to implement signal processing tasks, the sensor platform configured to receive signals from at least one sensor coupled thereto; and a processor; a wireless communication circuit coupled to the sensor platform, wherein the wireless communication circuit comprises a link master controller configured to establish a link to communicate with a wireless device and transfer data thereto; and a memory coupled to the sensor platform.

20. The wireless wearable sensor apparatus of clause 19, wherein the link master controller is configured to control data transmission over a communication link established with the wireless device, comprising timing control and frequency control.

21. The wireless wearable sensor apparatus of clause 19, wherein the processor employs a low-power low-memory data storage and transfer scheme wherein sensor data is stored as records, each with a type identifier.

22. The wireless wearable sensor apparatus of clause 21, wherein the data records are transferred to an external device by the wireless communication circuit in a packet payload in a format that is the same format used to store the data records in the memory.

23. The wireless wearable sensor apparatus of clause 21, wherein the data records are stored in the memory sequentially with variable length to optimize space usage in the memory.

24. The wireless wearable sensor apparatus of clause 21, comprising a data directory that allows fast read access to the data records stored in the memory.

25. The wireless wearable sensor apparatus of clause 24, wherein the data directory allows fast counting of the data records by type.

26. The wireless wearable sensor apparatus of clause 21, wherein each data record stored in the memory comprises an error-detecting code to detect data record corruption.

27. The wireless wearable sensor apparatus of clause 19, wherein the processor employs a high-assurance integrity data storage and transfer scheme.

28. The wireless wearable sensor apparatus of clause 26, wherein when the processor reads a data record from the memory prior to data packet transfer to an external device by the wireless communication circuit, the error-detecting code is checked by the processor.

29. The wireless wearable sensor apparatus of clause 21, wherein when the processor detects corruption of the stored data record, an error signal is sent to an external device.

30. The wireless wearable sensor apparatus of clause 28, wherein each packet transferred from the wireless communication circuit to the external device contains an error-detecting to be used by the external device to detect packet corruption.

1-3. (canceled)

4. A wireless wearable sensor apparatus, comprising:
a sensor platform comprising a signal processing device comprising a computational engine to implement signal processing tasks, the sensor platform configured to receive signals from at least one sensor coupled thereto; and
a wireless communication circuit coupled to the sensor platform, wherein the wireless communication circuit comprises a link master controller configured to communicate with a wireless device and transfer data thereto; and
wherein the link master controller is configured to control data transmission over a communication link established with the wireless device, comprising timing control and frequency control;
wherein the signal processing device comprises hard coded signal processing functions; and
wherein at least a portion of the signal processing device comprises programmable signal processing functions and execution units for optimized calculations.

5. The wireless wearable sensor apparatus of claim 4, wherein the signal processing device comprises an interface to a processor.

6. The wireless wearable sensor apparatus of claim 5, wherein the interface comprises:
at least one first-in-first-out (FIFO) register;
dual port memories; and
a direct memory access (DMA) engine to directly access processor memory.

7. The wireless wearable sensor apparatus of claim 5, wherein the interface comprises contention recognition or avoidance, and further comprising an electronics interface module coupled to the sensor platform.

8. (canceled)

9. The wireless wearable sensor apparatus of claim 7, comprising:
a sensor interface coupled to the sensor platform;
a flex circuit coupled to the sensor interface; and
one or more sensors coupled to the flex circuit.

10-11. (canceled)

12. A wireless wearable sensor apparatus, comprising:
a sensor platform comprising a signal processing device comprising a computational engine to implement signal processing tasks, the sensor platform configured to receive signals from at least one sensor coupled thereto;
a wireless communication circuit coupled to the sensor platform, wherein the wireless communication circuit comprises a link master controller configured to establish a link to communicate with a wireless device and transfer data thereto; and
an accelerometer coupled to the sensor platform;
wherein the link master controller is configured to control data transmission over a communication link established with the wireless device, comprising timing control and frequency control; and
further comprising a resampling frequency correction processor.

13. The wireless wearable sensor apparatus of claim 12, wherein the resampling frequency correction processor is provided in the accelerometer.

14. The wireless wearable sensor apparatus of claim 12, wherein the resampling frequency correction processor is provided in the signal processing device.

15. The wireless wearable sensor apparatus of claim 12, wherein the resampling frequency correction processor comprises:
a reference clock;
a fixed up-sample block;
a digital filter;
a programmable down-sample block; and
a control circuit that selects a down-sample coefficient based on comparison of timing of an accelerometer signal and the reference clock.

16. The wireless wearable sensor apparatus of claim 12, wherein the resampling frequency correction processor is configured to synchronize to a reference clock in a sliding window to generate a precise sampling rate.

17. The wireless wearable sensor apparatus of claim 12, wherein the resampling frequency correction processor is configured to set the down-sampling coefficient for each frame of data from the accelerometer signal.

18. The wireless wearable sensor apparatus of claim 12, wherein the resampling frequency correction processor is configured to track an accelerometer timing signal continuously and select the down-sampling coefficient to minimize any accumulated timing error.

19-20. (canceled)

21. A wireless wearable sensor apparatus, comprising:
a sensor platform comprising:
a signal processing device comprising a computational engine to implement signal processing tasks, the sensor platform configured to receive signals from at least one sensor coupled thereto; and
a processor;
a wireless communication circuit coupled to the sensor platform, wherein the wireless communication circuit comprises a link master controller configured to establish a link to communicate with a wireless device and transfer data thereto; and
a memory coupled to the sensor platform;
wherein the link master controller is configured to control data transmission over a communication link established with the wireless device, comprising timing control and frequency control; and
wherein the processor employs a low-power low-memory data storage and transfer scheme wherein sensor data is stored as records, each with a type identifier.

22. The wireless wearable sensor apparatus of claim 21, wherein the data records are transferred to an external device by the wireless communication circuit in a packet payload in a format that is the same format used to store the data records in the memory.

23. The wireless wearable sensor apparatus of claim 21, wherein the data records are stored in the memory sequentially with variable length to optimize space usage in the memory.

24. The wireless wearable sensor apparatus of claim 21, comprising a data directory that allows fast read access to the data records stored in the memory.

25. The wireless wearable sensor apparatus of claim 24, wherein the data directory allows fast counting of the data records by type.

26. The wireless wearable sensor apparatus of claim 21, wherein each data record stored in the memory comprises an error-detecting code to detect data record corruption.

27. The wireless wearable sensor apparatus of claim 21, wherein the processor employs a high-assurance integrity data storage and transfer scheme.

28. The wireless wearable sensor apparatus of claim 26, wherein when the processor reads a data record from the memory prior to data packet transfer to an external device by the wireless communication circuit, the error-detecting code is checked by the processor.

29. The wireless wearable sensor apparatus of claim 21, wherein when the processor detects corruption of the stored data record, an error signal is sent to an external device.

30. The wireless wearable sensor apparatus of claim 28, wherein each packet transferred from the wireless communication circuit to the external device contains an error-detecting to be used by the external device to detect packet corruption.
